(19) United States
(12) Patent Application Publication
(10) Pub. No.: US 2010/0002581 A1
(43) Pub. Date: Jan. 7, 2010

(54) Method for Inter-Router Dual-Function Energy- and Area-Efficient Links for Network-on-Chips

(75) Inventors: Ahmed Louri, Tucson, AZ (US); Janet Meiling Wang Roveda, Tucson, AZ (US); Avinash K. Kodi, Athens, OH (US); Ashwini Sarathy, Hillsboro, OR (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: The Arizona Board of Regents on Behalf of The University of Arizona, Tucson, AZ (US)

(21) Appl. No.: 12/418,701

(22) Filed: Apr. 6, 2009

Related U.S. Application Data
(60) Provisional application No. 61/123,022, filed on Apr. 4, 2008.

(51) Int. Cl. H04L 12/26; H04L 12/28

(52) U.S. Cl. 370/230; 370/351

(57) ABSTRACT

The present invention provides methods for connecting routers and transmitting data along inter-router links within Nework-on-Chip (NoC) architectures.

### CROSS-REFERENCE TO RELATED APPLICATIONS

The present patent application claims priority under 35 U.S.C. § 119(e) to U.S. Provisional Patent Application Ser. No. 61/123,022 filed on Apr. 4, 2008, the entirety of which is herein incorporated by reference.

### GOVERNMENT RIGHTS

This invention was made with government support under contract number 0725765 awarded by the National Science Foundation. The government has certain rights in the invention.

### FIELD OF INVENTION

The present invention relates to the storage and transmission of data in electrical devices. Specifically, the invention relates to methods for storing and transmitting data within Network-on-Chip architectures.

### BACKGROUND

Advancements in complementary metal-oxide semiconductor (CMOS) fabrication and processing technology has allowed for shrinkage of circuit features and enabled the integration of multiple processing cores into System-on-Chip (SoC) platforms. However, feature scaling into the deep sub-micron regime has revealed interconnect design issues such as global wire delays, which do not scale as fast as gate delays, and limit the efficacy of design techniques typically used in traditional single-chip architectures. To address issues with wire delays in SoC architectures, it is possible to adopt one of a group of more flexible, scalable, packet-switched architectures, known as Network-on-Chip (NoC) or On-Chip Network (OCN).

### SUMMARY

In a first aspect, the invention provides for methods for electrically coupling routers within a network-on-chip architecture comprising (i) electrically connecting an output port of a first router to an input of a three-state repeater, and (ii) electrically connecting an output of the three-state repeater to an input of a second router. Example implementations of the methods of the first aspect may further comprise applying a control signal to the three-state repeater, wherein in response to receiving the control signal, the three-state repeater operates in either a first mode or in a second mode, wherein the first mode comprises transmitting a bit of data received by the three-state repeater, and wherein the second mode comprises storing a bit of data in the three-state repeater. In such example implementations, the control signal may be a congestion signal, and the congestion signal may be transmitted by the second router.

The second router may generate the congestion signal in response to a determination that more than a threshold number of buffer slots within an input virtual channel buffer are full. In an example implementation of the methods of the first aspect, a plurality of buffer slots within the second router may be statically allocated to the input virtual channel buffer. In another example implementation of the methods of the first aspect, a plurality of buffer slots may be dynamically allocated to the input virtual channel buffer.

Example implementations of the methods of the first aspect may further comprise: (i) transmitting a congestion signal from the second router to a control block, (ii) processing the congestion signal within the control block, and (iii) transmitting a processed congestion signal from the control block to the three-state repeater. In such example implementations, processing the congestion signal within the control block may comprise one of the following methods: (i) Using a switched capacitor that transmits the congestion signal through the charging and discharging of the capacitor (ii) Double sampling the congestion signal in order to enable high operating frequencies (iii) Computing the next state of the congestion signal using digital logic gates in order to enable a more robust control of the three-state repeaters.

In other example implementations of the methods of the first aspect, the methods may also comprise electrically coupling a control block to the three-state repeater. In such example implementations, additional example implementations may comprise: (i) transmitting a bit of data from the first router to the three-state repeater, (ii) transmitting a congestion signal from the second router to the control block, (iii) processing the congestion signal within the control block to develop a control signal, (iv) transmitting the control signal from the control block to the three-state repeater, and (v) in response to receiving the control signal from the control block, either transmitting the bit of data to the second router or holding the bit of data in the three-state repeater, depending on a characteristic of the control signal received from the control block.

In a second aspect, the invention provides methods for transmitting data within a Network-on-Chip (NoC) architecture comprising: (i) transmitting a first bit of data from a first router to a first three-state repeater, (ii) transmitting a second bit of data from a first router to a second three-state repeater, (iii) transmitting a signal indicating a congestion status of a second router from the second router to a first control block, (iv) processing the signal indicating a congestion status of the second router within the first control block to generate a first control signal, (v) transmitting the first control signal from the first control block to the first three-state repeater, (vi) transmitting the signal indicating a congestion status of the second router from the first control block to the second control block, (vii) processing the signal indicating a congestion status of the second router within the second control block to generate a second control signal, and (viii) transmitting the second control signal to the second three-state repeater.

In example implementations of the methods of the second aspect, the signal indicating the congestion status of the second router may be a congestion signal generated by the second router. In such example implementations, the congestion signal may be generated in response to a determination that more than a threshold number of buffer slots within an input virtual channel buffer are full. In additional example implementations, a plurality of buffer slots may be statically allocated to the input virtual channel buffer. In other additional example implementations, a plurality of buffer slots may be dynamically allocated to the input virtual channel buffer.

In a third aspect, the invention provides for methods for electrically coupling a router within a network-on-chip architecture comprising: (i) electrically connecting an output connection of a first router to an input connection of a first three-state repeater, (ii) electrically connecting an output connection of the first three-state repeater to an input connection of a second three-state repeater, (iii) electrically connecting an output connection of the second-three state repeater to an input connection of a second router, and (iv) electrically connecting a control block to both the first three-state repeater and the second three-state repeater. In example implementations of the methods of the third aspect, the methods may further comprise (i) receiving at the first three-state repeater a control signal from the control block, and (ii) in response to receiving a control signal either (a) holding a bit of data within the first three-state repeater or (b) transmitting a bit of data from the first three-state repeater, depending on a characteristic of the control signal received from the control block.

In other example implementations of the methods of the third aspect, the methods may further comprise: (i) receiving at the control block one or more signals transmitted from the second router, and (ii) in response to receiving one or more signals from the second router, transmitting a first control signal to the first three-state repeater and a second control signal to the second three-state repeater. In such example implementations of the methods of the third aspect, the one or more signals transmitted from the second router may comprise a congestion signal.

### BRIEF DESCRIPTION OF FIGURES

FIG. 1 depicts a schematic diagram of a conventional inter-router link in accordance with the prior art

FIG. 2 depicts a schematic diagram of inter-router links that may be used in accordance with an aspect of the invention.

FIG. 3 depicts a schematic diagram of control blocks that may be used in accordance with an aspect of the invention.

FIG. 4 depicts a timing diagram depicting signals present within an inter-router link configured to operate in accordance with an aspect of the invention.

FIG. 5 depicts a schematic diagram of an inter-router link in accordance with one aspect of the invention.

FIGS. 6a and 6b depict a schematic diagram and a state diagram of an example control block that may be used in accordance with one aspect of the invention

### DETAILED DESCRIPTION OF EXAMPLE EMBODIMENTS

As feature sizes decrease to the deep sub-micron regime, the trend towards integrating more functionality onto a single chip has led to the rise of the System-on-Chip (SoC) paradigm. In SoC architectures, gate delays continue to scale down with successive technology generations while interconnect delays increase. This increased wire delay constraint in SoCs has driven the design and development of a modular and scalable packet-switched Network-on-Chip (NoC) paradigm. As NoCs are being targeted at complex systems such as SoCs, accurate estimation of their performance, power dissipation, and area overhead are essential during the design phase.

These on-chip networks are characterized by channels for data transmission and the routers for storing, arbitration, and switching functions performed by input buffers, arbiters, and the cross-bar. In such networks, a substantial portion of the power consumed by the network is consumed by the input buffers of the routers, and a substantial portion of the area used by the router is dominated by the cross-bar.

Current wire design trends have shown that signal delay along a wire increases quadratically with the length of the wire. In order to meet stringent timing requirements imposed by very-large-scale-integration (VLSI) designs, repeaters may be inserted along the wire to adjust the delay such that it is linearly dependent on the length of the wire. In accordance with the methods described herein, repeaters can be configured beyond their conventional functionality in order to sample and hold data values when required, thus providing data storage. As such, such modified repeaters can be used as buffers along the channel at high network loads when there are no remaining virtual channels (VCs) or buffer slots in the router.

The methods described herein employ novel techniques at the channel and router buffer. For example, at the channel, conventional repeaters are replaced with enhanced repeaters that are configured to operate as buffers when required. Novel techniques utilizing a control bock along the congestion line may also be used to control the functionality of the enhanced repeaters. Such techniques may enable the enhanced repeaters to adaptively function as buffers during congestion. Other techniques that may be applied include the static or dynamic buffer allocation at the input buffer of a router.

### Channel Buffer Implementation

In known designs, conventional repeaters are inserted along a link between routers, and are sized and spaced according to a first-order resistor-capacitor (RC) wire delay model. In accordance with one aspect of the invention, the conventional repeaters are replaced with three-state repeaters. A single stage of the three-state repeaters comprises a three-state repeater inserted segment along all of the wires within a particular link. Each such repeater stage may receive a control input from the corresponding control block. When the control input to a repeater stage is high, the repeaters in that stage function as channel buffers. When the control input to the repeater stage is low, the three-state repeaters function as conventional repeaters. Each stage can be controlled such that in the absence of congestion, the three-state repeater operates similarly to a conventional repeater—data moves through the link without being held in place by the three-state repeater. When the control block is activated in the presence of congestion, the control block can activate or tri-state the three-state repeaters.

Once activated, the three-state repeaters function as channel buffers and the data bits are held in position. Once congestion is alleviated, the control logic can be adjusted, and the three-state repeaters can function as conventional repeaters. Since the three-state repeaters can adaptively function as channel buffers, a given level of network performance can be achieved using routers with a reduced number of input buffers, effectively reducing the size and power consumption of a router.

### Control Block Implementation

A control block can be used in conjunction with one or more three-state repeaters to enable the three-state repeaters to adaptively function as channel buffers. In one example implementation, each stage of three-state repeaters is controlled by its own control block. In another example implementation, a single control block may be used to control multiple stages.

In an example implementation, a control block receives a congestion signal from a router and uses a switched capacitor to delay the congestion signal by one clock cycle. In the following clock cycle, the channel buffer stage is tri-stated, and the congestion signal is also passed to the next control block. By tri-stating stages of channel buffers and passing the congestion signal to control blocks along a given link, the data present at a particular stage is held in place until the control block for that particular stage receives a congestion release signal, which in turn triggers the control block to cause the channel buffers to revert to behaving as conventional repeaters. Unlike conventional repeaters, this control block can function as both a delay module and a repeater for the congestion signal at variable clock frequencies.

In a second example implementation, the control block double samples the congestion signal using two flip-flops that have clocks offset with respect to each other. This example implementation tri-states and releases the channel buffer stages in a similar way as the first example implementation. In addition, double sampling the congestion signal ensures correct detection of the signal under high operating frequencies.

In a third example implementation, a single control block is employed to control all the channel buffer stages along the link between the two routers. This example implementation employs a flip-flop to delay the congestion signal by one clock cycle. In the same clock cycle, the internal logic in the control block determines the state of the congestion signal in the next clock cycle. The control block operates with two logic states: ‘Hold’ and ‘Release’. In the hold state, the control block delays the incoming congestion signal by one clock cycle before transmitting it to each successive channel buffer stage. Hence each channel buffer stage is successively tri-stated to hold the data in position, until the congestion signal is released. In addition to the congestion signal, the router outputs a ‘release stage’ signal to the control block. During congestion, the router may request the control block to release any given channel buffer stage, by setting the corresponding bit in the ‘release stage’ signal. The control block then moves to the release state and resets the control signal to the particular stage whose release stage bit has been set by the router.

In the third example implementation, the control block outputs one control signal per channel buffer stage and can thereby tri-state or release each stage independent of the other stages. This capability can be utilized to enable error-checking and error-correction of an individual flit along the link, without affecting the data held by the other stages. In addition, parts of the router that may be ‘Idle’ during congestion, may perform a look-ahead routing computation for a flit held along the link, thereby reducing the processing delay for the flit in the router.

In addition to the independent control of each channel buffer stage, the third example implementation offers a relaxed timing requirement compared to conventional repeaters. The clock-to-q delay of the flip-flop does not limit the correct operation of the three-state repeaters. The control signal may arrive at a repeater stage at any time prior to the next clock cycle, as the data that is to be held will be lost or overwritten only at the next clock edge.

In all the above example implementations and other example implementations, the control block may also be turned off by the router, using clocking circuitry, thereby reducing power consumption.

### Additional Aspects

In a first aspect, the invention provides for methods for electrically coupling routers within a network-on-chip architecture comprising (i) electrically connecting an output port of a first router to an input of a three-state repeater, and (ii) electrically connecting an output of the three-state repeater to an input of a second router. Rather than using conventional repeaters, which do not store any other information that is presented at the input of the conventional repeater, the three-state repeaters used in example implementations of the methods of this aspect are capable of storing at least one bit of data. Along any particular path between two routers within a NoC architecture, one or more three-state repeaters may be inserted, providing the ability to store multiple bits, flits, packets, or even larger quantities of data along the particular path between two routers. Further, where there are multiple pathways between two routers, multiple three-state repeaters may be arranged in stages, allowing for data transmitted along multiple pathways to be stored in corresponding locations along the multiple pathways between the routers.

In example implementations of the methods of the first aspect, the methods may further comprise applying a control signal to the three-state repeater. This control signal may be used to establish which state a particular three-state repeater or stage of three-state repeaters is in. In an example implementation of such methods, the three-state repeater may be selectively directed to operate in one of two modes. In one mode, the three-state repeater operates similarly to a conventional repeater, in the sense that it retransmits data received at its input according to a performance characteristic of the repeater. In a second mode, the three state repeater acts as a storage device, capable of storing one bit of data within the three-state repeater.

The control signal may be used to set or switch the state of the three-state repeater. In response to receiving the control signal, the three-state repeater operates in either of the two modes described herein. For example, a particular control signal may instruct the three-state repeater to operate as a storage device, and a different control signal may instruct the three-state repeater to retransmit data as it arrives at the input of the three-state repeater. In such example implementations, the control signal may be a congestion signal, such as a congestion signal transmitted by the second router. In another example implementation, a control signal may be transmitted by a control block in response to receiving any of a number of signals, such as a congestion signal, a clock signal, or a combination of signals from a router. Further, the control signal may be transmitted by a control block that has processed one or more signals received from other components with the NoC architecture.

In additional example implementations of the methods of this aspect, the second router may generate the congestion signal in response to a determination that more than a threshold number of buffer slots within an input virtual channel buffer are full. In an example implementation of the methods of the first aspect, a plurality of buffer slots within the second router may be statically allocated to the input virtual channel buffer. In another example implementation of the methods of the first aspect, a plurality of buffer slots may be dynamically allocated to the input virtual channel buffer.

In implementations utilizing static allocation, congestion control logic within a router enables a congestion control signal when more than a threshold number of buffer slots, or all of the buffer slots allocated to a particular virtual channel (VC) are full. In an example static allocation implementation, equal partitions of buffer space are allocated among all of the incoming packets. A state table is also associated with each virtual channel, and the state table is used to track the state of each incoming flit of data and ensure that flits are properly routed. The enabled congestion control signal can be used to control the three-state repeaters, and instruct them to hold the data present at the three-state repeaters.

In implementations utilizing dynamic buffer allocation, buffer space within a router is reserved on a per-flit basis, which can enable higher buffer occupancy. In dynamic buffer allocation, an incoming flit may be assigned any free buffer slot, regardless of the packet associated with the flit. As with static allocation implementations, a state table is used to track flits as they enter and leave the buffer slots. When more than a threshold number of buffer slots are full, a congestion control signal can be enabled, and this congestion control signal can in turn be used to instruct the three-state repeaters to store the data present at the three-state repeaters.

Example implementations of the methods of the first aspect may further comprise: (i) transmitting a congestion signal from the second router to a control block, (ii) processing the congestion signal within the control block, and (iii) transmitting a processed congestion signal from the control block to the three-state repeater.

A control block may comprise any of a number of circuits capable of receiving a signal, such as a congestion signal from a router, processing the signal, and transmitting the signal to a three-state repeater or stage of three-state repeaters. For example, the control block may boost or amplify the incoming signal, or it may perform any of a number of other processes, such as error-checking, sampling, or other processes. In such example implementations, processing the congestion signal within the control block may comprise one of the following methods: (i) Using a switched capacitor that transmits the congestion signal through the charging and discharging of the capacitor (ii) Double sampling the congestion signal in order to enable high operating frequencies (iii) Computing the next state of the congestion signal using digital logic gates in order to enable a more robust control of the three-state repeaters.

All of the elements described in relation to the methods of the first aspect may be combined with each other, for example, in some example implementations of the methods of the first aspect, the methods may also comprise electrically coupling a control block to the three-state repeater. In such example implementations, additional example implementations may comprise: (i) transmitting a bit of data from the first router to the three-state repeater, (ii) transmitting a congestion signal from the second router to the control block, (iii) processing the congestion signal within the control block to develop a control signal, (iv) transmitting the control signal from the control block to the three-state repeater, and (v) in response to receiving the control signal from the control block, either transmitting the bit of data to the second router or holding the bit of data in the three-state repeater, depending on a characteristic of the control signal received from the control block.

The invention described herein also provides methods in accordance with a second aspect. This second aspect provides methods for transmitting data within a Network-on-Chip (NoC) architecture comprising: (i) transmitting a first bit of data from a first router to a first three-state repeater, (ii) transmitting a second bit of data from a first router to a second three-state repeater, (iii) transmitting a signal indicating the congestion status of a second router from the second router to a first control block, (iv) processing the signal indicating a congestion status of the second router within the first control block to generate a first control signal, (v) transmitting the first control signal from the first control block to the first three-state repeater, (vi) transmitting the signal indicating a congestion status of the second router from the first control block to the second control block, (vii) processing the signal indicating the congestion status of the second router within the second control block to generate a second control signal, and (viii) transmitting the second control signal to the second three-state repeater.

Any means of transmitting bits of data may be used. In an example implementation, an output connection of the first router is electrically coupled to an input of the first three-state repeater, an output of the first three-state repeater is electrically coupled to an input of the second three-state repeaters, and an output connection of the second three-state repeater is electrically coupled to an input of the second router. Electrical connections may also be established between outputs of the first and second control blocks and control inputs of the three-state repeaters.

In an example implementation, the signal indicating the congestion status of the second router is transmitted to the control block associated with the three-state repeater electrically connected to an input of the router. The control block that initially received the signal indicating the congestion status of the second router may then hold the received signal for one or more clock cycles, and then transmit a control signal to its associated three-state repeater or repeaters, and also transmits the signal indicating the congestion status of the second router to the control block associated with another set of three-state repeaters along a particular link.

In example implementations of the methods of the second aspect, the signal indicating the congestion status of the second router may be a congestion signal generated by the second router. In such example implementations, the congestion signal may be generated in response to a determination that more than a threshold number of buffer slots within an input virtual channel buffer are full. In additional example implementations, a plurality of buffer slots may be statically allocated to the input virtual channel buffer. In other additional example implementations, a plurality of buffer slots may be dynamically allocated to the input virtual channel buffer. Any of the aspects of static and/or dynamic allocation described in relation to the first aspect may be used in relation to methods of the second aspect.

In a third aspect, the invention provides for methods for electrically coupling a router within a network-on-chip architecture comprising: (i) electrically connecting an output connection of a first router to an input connection of a first three-state repeater, (ii) electrically connecting an output connection of the first three-state repeater to an input connection of a second three-state repeater, (iii) electrically connecting an output connection of the second-three state repeater to an input connection of a second router, and (iv) electrically connecting a control block to both the first three-state repeater and the second three-state repeater.

Any of the three-state repeaters and methods for operating three-state repeaters described herein may be used in implementations of the methods of the third aspect. In some example implementations of the methods of the third aspect, a single control block is used to control multiple three-state repeaters or multiple stages of three-state repeaters. A single control block may be used to control all of the three-state repeaters in a particular link between two routers.

In example implementations of the methods of the thirds aspect, the methods may further comprise (i) receiving at the first three-state repeater a control signal from the control block, and (ii) in response to receiving a control signal either (a) holding a bit of data within the first three-state repeater or (b) transmitting a bit of data from the first three-state repeater, depending on a characteristic of the control signal received from the control block. Any of the methods for applying a control signal to a three state repeater described herein may be used in implementations of the methods of the third aspect.

In other example implementations of the methods of the third aspect, the methods may further comprise: (i) receiving at the control block one or more signals transmitted from the second router, and (ii) in response to receiving one or more signals from the second router, transmitting a first control signal to the first three-state repeater and a second control signal to the second three-state repeater. In such example implementations of the methods of the third aspect, the one or more signals transmitted from the second router may comprise a congestion signal. In such example implementations, multiple signals may be transmitted from the second router to the control block. In addition to a congestion signal, the router may also transmit an enable signal, a clock signal, and a release stage signal, that instructs the control block to allow a particular stage to transmit or hold data.

### EXAMPLES

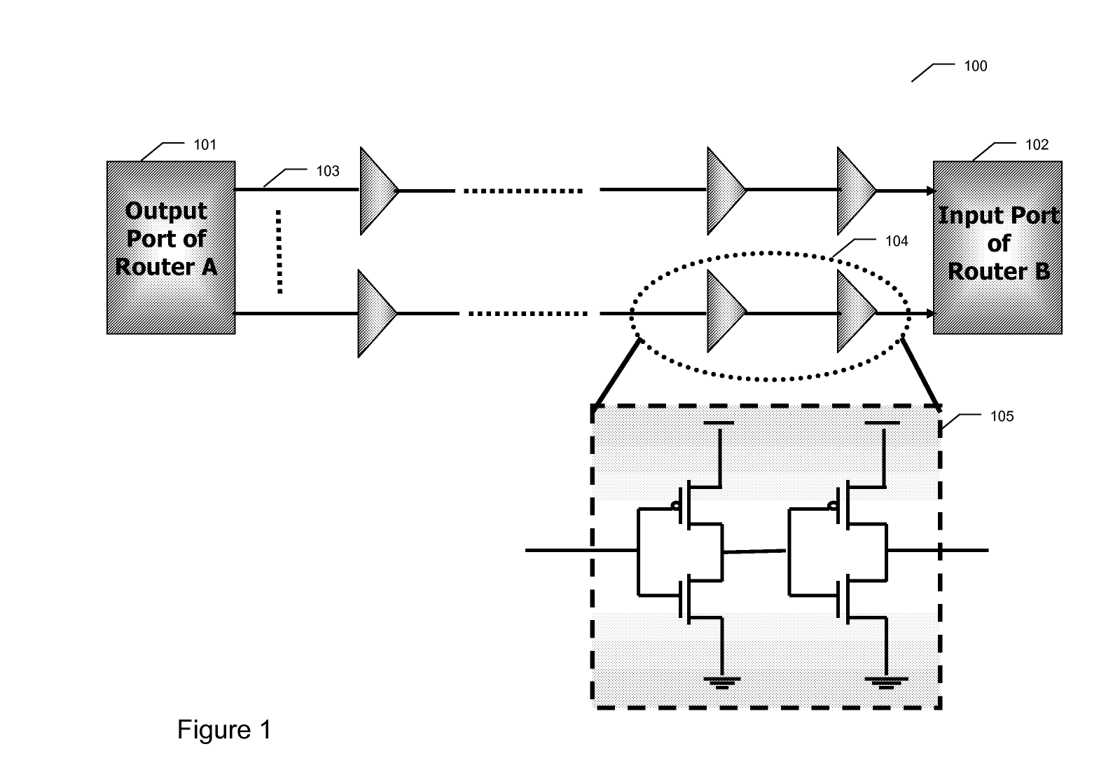

Turning now to the figures, FIG. 1 depicts a schematic diagram of a conventional inter-router link 100 in accordance with the prior art. In FIG. 1, the routers 101 and 102 are connected with a series of pathways 103 that include a plurality of conventional repeaters, such as repeater 104. As shown in the inset diagram 105, each repeater comprises a pair of complementary transistors, and is unable to store any data. Rather, the conventional repeaters, such as repeater 104, simply transmit any data that is presented.

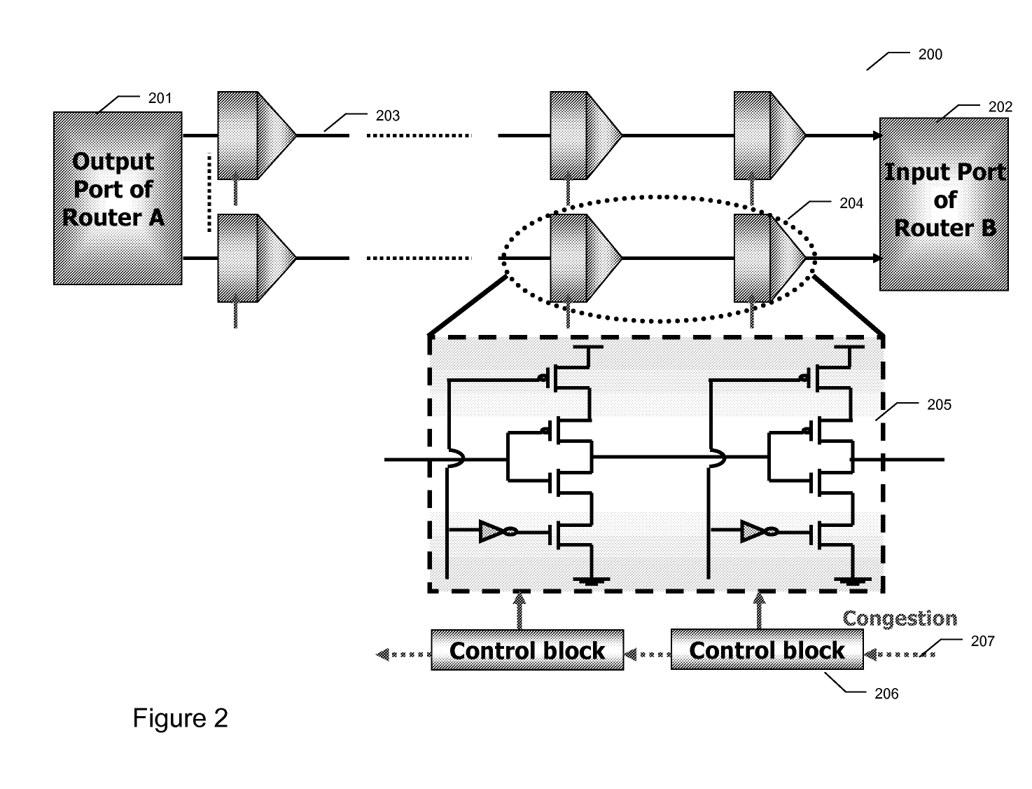

In contrast, FIG. 2 depicts an inter-router link that may be used to implement one or more of the methods described herein. Within link 200, routers 201 and 202 are electrically connected via a plurality of pathways, 203. Along each of the pathways 203 are a plurality of three-state repeaters, such as three-state repeater 204. As shown in inset 205, three-state repeater 204 comprises four transistors configured to allow the three-state repeater 204 to adaptively store or transit a bit of data, depending on the signal received from control block 206. As shown in FIG. 2, a congestion signal 207 may transmitted to control block 206, and may be used to generate a control signal transmitted to three-state repeater 204.

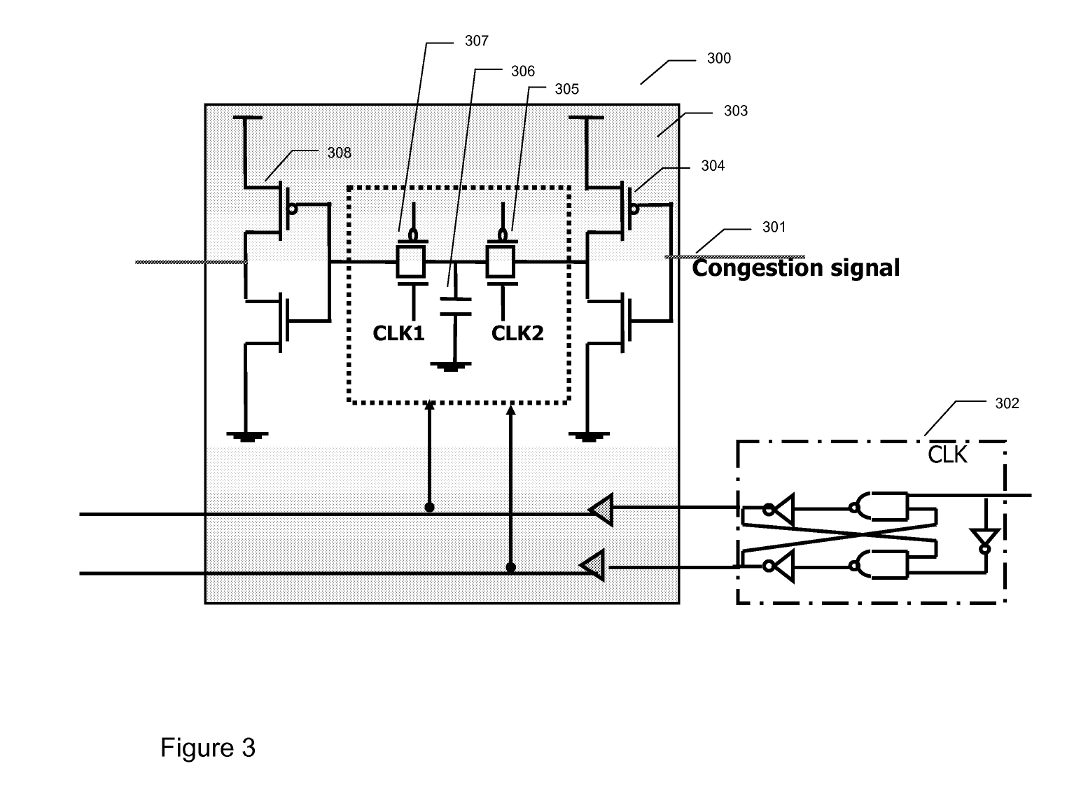

FIG. 3 depicts a schematic diagram 300 of an example control block that can be used in example implementations of the methods described herein. As shown in FIG. 3, a congestion signal 301 and a clock 302 are electrically connected to control block 303. The congestion signal is transmitted to a pair of complementary transistors 304, and retransmitted to flip-flop 305, which is controlled by one of the signals from clock 302, marked as CLK2. Flip-flop 305 is used to charge capacitor 306, which stores the value of the congestion signal 301. Capacitor 306 can be discharged by flip-flop 307, which is controlled by a second signal from clock 302, marked as CLK 1. Flip-flop 307 passes the signal stored at capacitor 306 to a second pair of complementary transistors 308, which can transmit an output signal, such as a control signal, or an output to a subsequent control block, or both. By adjusting the clock 302 and the response of flip-flops 305 and 307, the congestion signal can be delayed within the control block. For example, the control signal may be delayed for one or more clock cycles before the control block provides a control signal to a stage of three-state repeaters and/or a subsequent control block.

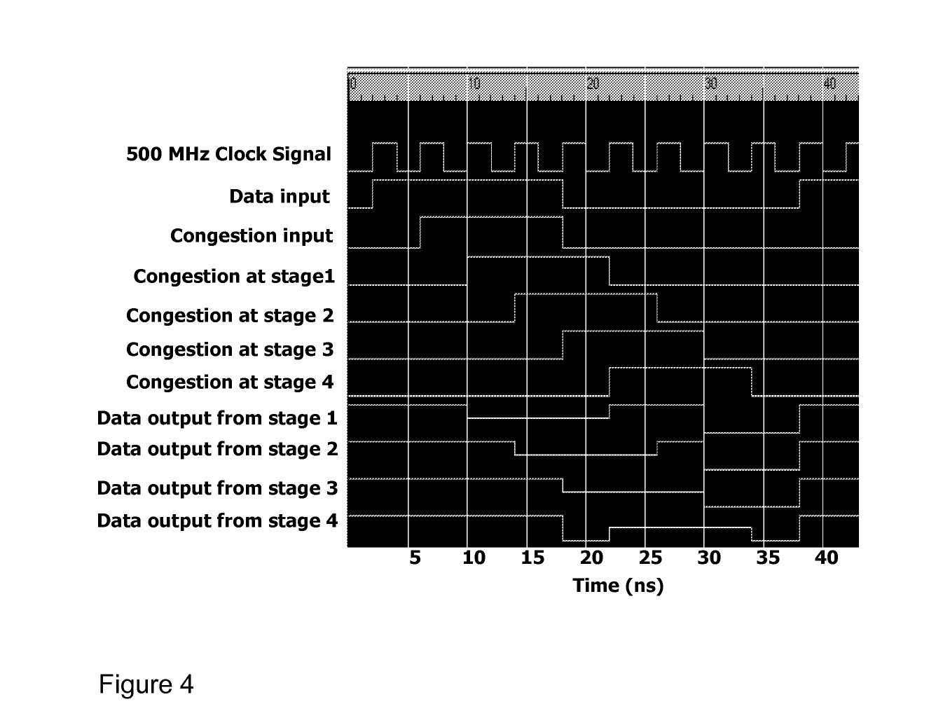

FIG. 4 depicts an example timing diagram depicting how congestion input, congestion at each stage, and data signals may propagate through an inter-router link that includes four stages of three-state repeaters. As shown in FIG. 4, a 500 MHz clock signal is used to control the timing of all of the components within the inter-router link, and oscillates between a high state and low state during each clock cycle, with approximately equal time spent in both states. The trace marked “Data input” represents an example set of data, containing both high and low states. The trace marked “Congestion input” represents a congestion signal generated by a router with the inter-router link.

The trace marked “Congestion at stage 1” depicts the congestion signal as it is received at stage 1, the closest stage to the router transmitting the congestion signal. As shown in FIG. 4, the Congestion at stage 1 is delayed one clock cycle with respect to the congestion signal itself. Prior to receiving the congestion signal, data is output from stage 1 as it is received, as depicted in the trace marked “Data output from stage 1.” The trace marked “Data output from stage 1” also shows that once the congestion signal is received at stage one, stage one stops outputting data until the congestion seen at stage one returns to a low state.

As shown in FIG. 4, each stage receives a congestion signal delayed by one clock cycle, as seen in the traces marked “Congestion at stage 2,” “Congestion at stage 3,” and “Congestion at stage 4.” Also, each stage behaves similarly to stage 1, such that when a stage receives a congestion signal, it stops outputting data until the congestion signal returns to a low state.

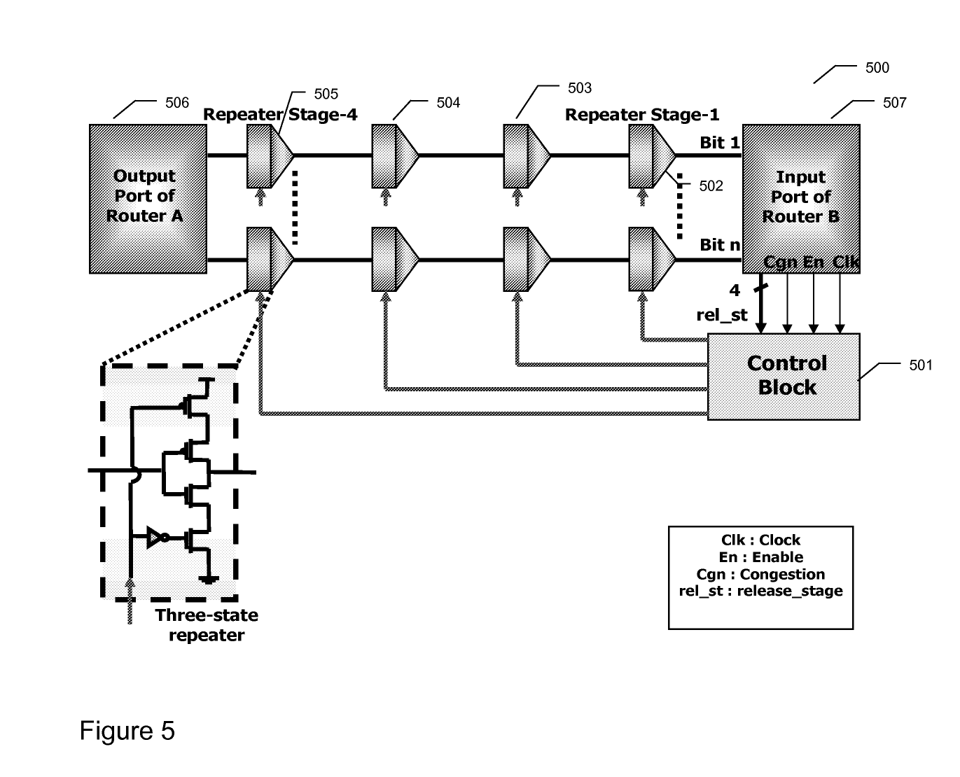

FIG. 5 depicts a schematic diagram of a inter-router link 500 where a control block 501 is used to control all of the stages of three-state repeaters 503-505 in a link between routers 506 and 507. As shown in FIG. 5, router 507 is electrically connected to control block 501 and can send several different signals to control block 501. The signal marked Clk is a clock signal, used to provide synchronization between the router 507 and the control block 501. The signal marked En is an enable signal used to turn the control block 501 on and off. For example, when there is no congestion in the router 507, the control block 501 may be turned off to draw less power. The signal marked Cgn is a congestion signal, used to notify the control block 501 of a congestion status of the router 507. The signals marked rel_st comprise a plurality of signals sent from the router 507 to the control block 501 to instruct the control block to allow a particular stage to transmit data.

As shown in FIG. 5, control block 501 is also electrically coupled to each of the three-state repeater stages 502-505, and can be used to control whether the three-state repeaters in any stage store or transmit the data present at that stage. For example, control block 501 could be used to implement a data flow similar to that depicted in FIG. 4. In another example, the control block 501 can be used to selectively hold data in place along a link between routers 506 and 507.

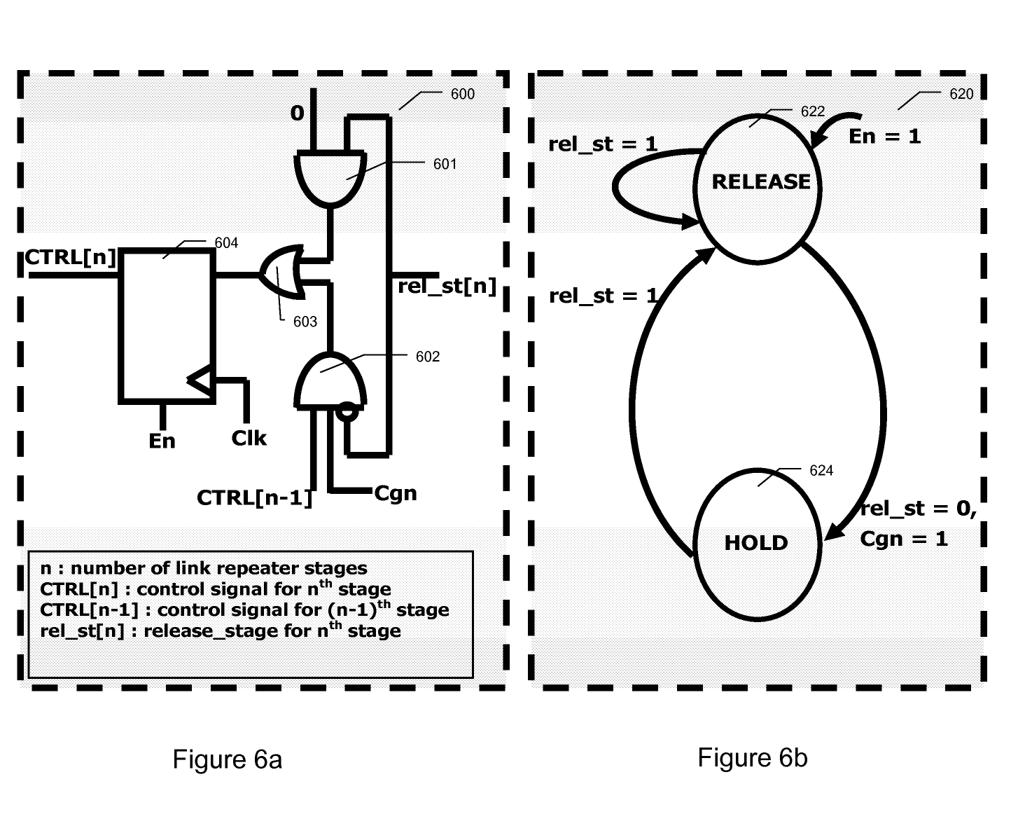

FIG. 6a depicts an example schematic diagram of a circuit 600 that may be used within a control block, such as control block 501 depicted in FIG. 5. As shown in the figure, “n” denotes the number of a one of a number of link repeater stages controlled by a control block. The line marked “CTRL[n]” denotes the control signal for the n^{th} stage, and the line marked “CTRL[n−1]” denotes the control signal for the (n−1)^{th} stage. The line marked “rel_st[n]” is a release_stage signal for the nth stage, indicating whether a particular stage should be released and allowed to transmit data.

The line marked “Cgn” is a congestion signal, the line marked “En” is an enable signal that may be used to activate or deactivate a control block or portion of a control block, and the line marked Clk is a clock signal. As shown in FIG. 6a, the rel_st[n] signal is passed to an AND gate 601, and an inverse of the rel_st[n] signal is passed to the three-input AND gate 602. A low signal, denoted as a “0” is also passed to AND gate 601. The three-input AND gate 602 also receives inputs from the congestion signal, marked as Cgn, and a control signal from the (n−1)^{th} stage, marked as CTRL[n−1]. Outputs from AND gate 601 and three-input AND gate 602 are electrically connected to inputs of OR gate 603, and an output of OR gate 603 is electrically connected an input of flip-flop 604, which receives also receives as inputs an enable signal, marked as En, a clock signal, marked as Clk. Flip-flop 604 operates on signals received at its inputs and presents at its output a control signal for a stage “n”, denoted as CTRL[n].

FIG. 6b depicts a state diagram 620 indicating conditions under which a CTRL[n] signal represents a release state 622 for a given stage or a hold state 624 for the given stage. When an enable signal is in a high state, marked in FIG. 6b as “En=1”, a signal has been sent activating a control block or portion of a control block, such as the portion of a control block depicted in FIG. 6a. Initially, the CTRL[n] signal will be in release state 622. If the release stage signal for the particular stage is at a high state, marked as rel_st =1, the CTRL[n] signal will continue to reflect the release state 622. If the release stage signal is at a low state, marked as rel_st=0 and the congestion signal is in a high state, marked as Cgn=1, the CTRL[n] signal will reflect the hold state 624. If while in the hold state 624, the release stage signal returns to a high state, marked as rel_st =1, the CTRL[n] signal will return to reflecting the release state 622.

The links described herein may be referred to as inter-router dual-function energy- and area-efficient links, or iDEAL. While the methods incorporating iDEAL architectures described herein have primarily been directed to implementations in a Network-on-Chip (NoC) context, those skilled in the art will understand that the described methods may be applied in Nework-on-Chips, System-on-Chips, embedded computing, including but not limited to embedded computing in avionics, hand-held device, mobile device, personal digital assistant (PDA), chip multiprocessor (CMP), and Lab-on-a-Chip environments. The described methods may also be used in connection with environments, such as nanotechnology.

Various arrangements and embodiments in accordance with the present invention have been described herein. All embodiments of each aspect of the invention can be used with embodiments of other aspects of the invention. It will be appreciated, however, that those skilled in the art will understand that changes and modifications may be made to these arrangements and embodiments, as well as combinations of the various embodiments without departing from the true scope and spirit of the present invention, which is defined by the following claims.

1. A method for electrically coupling routers within a network-on-chip architecture comprising:
electrically connecting an output port of a first router to an input of a three-state repeater; and
electrically connecting an output of the three-state repeater to an input of a second router.

2. The method of claim 1 further comprising applying control signal to the three state repeater, wherein in response to receiving the control signal, the three-state repeater operates in either a first mode or in a second mode, wherein the first mode comprises transmitting a bit of data received by the three-state repeater, and wherein the second mode comprises storing a bit of data in the three-state repeater.

3. The method of claim 2, wherein the control signal is a congestion signal.

4. The method of claim 3, wherein the congestion signal is transmitted by the second router.

5. The method of claim 4, wherein the congestion signal is generated in response to a determination that more than a threshold number of buffer slots within an input virtual channel buffer are full.

6. The method claim 5 wherein a plurality of buffer slots is statically allocated to the input virtual channel buffer.

7. The method of claim 5 wherein a plurality of buffer slots is dynamically allocated to the input virtual channel buffer.

8. The method of claim 4 further comprising:
transmitting the congestion signal from the second router to a control block;
processing the congestion signal within the control block; and
transmitting a processed congestion signal from the control block to the three-state repeater.

9. The method of claim 1 further comprising electrically coupling a control block to the three-state repeater.

10. The method of claim 9 further comprising:
transmitting a bit of data from the first router to the three-state repeater;
transmitting a congestion signal from the second router to the control block;
processing the congestion signal within the control block to develop a control signal;
transmitting the control signal from the control block to the three-state repeater; and
in response to receiving the control signal from the control block, either transmitting the bit of data to the second router or holding the bit of data in the three-state repeater, depending on a characteristic of the control signal received from the control block.

11. A method for transmitting data within a Network-on-Chip architecture comprising:
transmitting a first bit of data from a first router to a first three-state repeater;
transmitting a second bit of data from a first router to a second three-state repeater;
transmitting a signal indicating a congestion status of a second router from the second router to a first control block;
processing the signal indicating a congestion status of the second router within the first control block to generate a first control signal;
transmitting the first control signal from the first control block to the first three-state repeater;
transmitting the signal indicating a congestion status of the second router from the first control block to the second control block;
processing the signal indicating a congestion status of the second router within the second control block to generate a second control signal; and
transmitting the second control signal to the second three-state repeater.

12. The method of claim 11 wherein the signal indicating the congestion status of the second router is a congestion signal generated by the second router.

13. The method of claim 12, wherein the congestion signal is generated in response to a determination that more than a threshold number of buffer slots within a virtual channel are full.

14. The method claim 12 wherein a plurality of buffer slots is statically allocated to the virtual channel.

15. The method of claim 12 wherein a plurality of buffer slots is dynamically allocated to the virtual channel.

16. A method for electrically coupling routers within a network-on-chip architecture comprising:
electrically connecting an output connection of a first router to an input connection of a first three-state repeater;
electrically connecting an output connection of the first three-state repeater to an input connection of a second three-state repeater;
electrically connecting an output connection of the second-three state repeater to an input connection of a second router; and
electrically connecting a control block to both the first three-state repeater and the second three-state repeater.

17. The method of claim 16 further comprising:
receiving at the first three-state repeater a control signal from the control block; and
in response to receiving a control signal either (i) holding a bit of data within the first three-state repeater or (ii) transmitting a bit of data from the first three-state repeater, depending on a characteristic of the control signal received from the control block.

18. The method of claim 16 wherein further comprising:
receiving at the control block one or more signals transmitted from the second router; and
in response to receiving one or more signals from the second router, transmitting a first control signal to the first three-state repeater and a second control signal to the second three-state repeater.

19. The method of claim 18 wherein the one or more signals transmitted from the second router comprise a congestion signal.

20. A method for controlling a stage of three-state repeaters comprising:
receiving at a control block a signal indicating a congestion status of a router buffer; and
in response to receiving at a control block a signal indicating a congestions status of a router buffer, transmitting a signal from the control block to a three-state repeater designating a mode of operation of the three-state repeater.

21. The method of claim 20 wherein the signal indicating a congestion status of a router buffer is delayed by one clock cycle by the router.

22. The method of claim 20 wherein the signal indicating a congestion status of a router buffer is delayed by one clock cycle using a switched capacitor.

23. The method of claim 20 further comprising double-sampling the signal indicating a congestion status of a router buffer.

24. The method of claim 20 further comprising:
delaying a signal indicating a first congestion status of a router buffer; and
determining a value of a signal indicating a second congestion status of a router buffer
